(19) United States
(12) Patent Application Publication
(10) Pub. No.: US 2015/0354500 A1
(43) Pub. Date: Dec. 10, 2015

(54) ACTUATOR FOR AIRCRAFT ENGINE NACELLE

(71) Applicant: AIRCELLE, GONFREVILLE L'ORCHER (FR)

(72) Inventor: Pierre CARUEL, LE HAVRE (FR)

(73) Assignee: AIRCELLE, GONFREVILLE L'ORCHER (FR)

(21) Appl. No.: 14/830,258

(22) Filed: Aug. 19, 2015

Related U.S. Application Data
(63) Continuation of application No. PCT/FR2014/050403, filed on Feb. 25, 2014.

(30) Foreign Application Priority Data
Feb. 25, 2013 (FR) 13/51612

(51) Int. Cl. F02K 1/76

(52) U.S. Cl. CPC F02K 1/763

(57) ABSTRACT

The present disclosure provides an actuator for an aircraft turbojet engine nacelle, which is interposed between a stationary front part of the nacelle and a moveable rear part of the nacelle. The actuator includes a main actuating arm, and a secondary actuating arm which axially extends from a rear section suitable for being connected on the moveable rear part of the nacelle, to a front section secured to a main nut screwed on a worm drive, in particular, the secondary actuating arm being designed for overcoming a breakdown of the main actuating arm.

### CROSS-REFERENCE TO RELATED APPLICATIONS

This application is a continuation of International Application No. PCT/FR2014/050403, filed on Feb. 25, 2014, which claims the benefit of FR 13/51612, filed on Feb. 25, 2013. The disclosures of the above applications are incorporated herein by reference.

### FIELD

The present disclosure relates to an actuator for an aircraft turbojet engine nacelle.

### BACKGROUND

The statements in this section merely provide background information related to the present disclosure and may not constitute prior art.

An aircraft is moved by one or several turbojet engines each housed in a nacelle serving to channel the air flows generated by the turbojet engine which also accommodates an assembly of actuating devices providing various functions, when the turbojet engine is in operation or when stopped.

These actuating devices may in particular, comprise a mechanical thrust reversal system the role of which is to improve the braking capacity of the latter by redirecting towards the front at least part of the thrust generated by the turbojet engine during the landing of an airplane.

A nacelle generally has a tubular structure comprising an air inlet upstream of the turbojet engine, a median section intended to surround a fan of the turbojet engine, a downstream section accommodating a reverser, otherwise called thrust reversal device, and intended to surround the gas generator of the turbojet engine, and is generally terminated by an ejection nozzle the outlet of which is located downstream of the turbojet engine.

Modern nacelles are intended to accommodate a dual flow turbojet engine capable of generating by means of the fan blades, an air flow of which part, called hot or primary flow, circulates inside the combustion chamber of the turbojet engine, and of which the other part, called cold or secondary flow, circulates outside the turbojet engine through an annular passage, also called stream, formed between fairings of the turbojet engine and inner walls of the nacelle. The two air flows are ejected from the turbojet engine by the rear of the nacelle.

In this phase, the reverser obstructs the cold flow stream and directs the latter towards the front of the nacelle, thereby generating a counter-thrust which adds to the braking of the airplane wheels.

The means implemented for carrying out this reorientation of the cold flow vary depending on the type of reverser. However, in any case, the structure of a reverser comprises moveable cowls displaceable between a closed or “direct jet” position in which they close this passage and an open or “reverse jet” position in which they open a passage intended for the deflected flow in the nacelle. These cowls may fulfill a deflecting function or simply activate other deflecting means.

The translation of the moveable cowl is carried out along a longitudinal axis substantially parallel with the axis of the nacelle.

It is known from the prior technique, and in particular of document FR 2 916 426, a cascade-type thrust reverser of which the moveable cowl is integral and slidably mounted on guides disposed on either side of the suspension mast of the assembly formed by the turbojet engine and the nacelle thereof.

Each actuator is typically mounted between a stationary front part of the nacelle, for example on a front frame of the thrust reverser, and a moveable rear part of the nacelle.

It has been represented on FIG. 1 an actuator of the prior art.

Such an actuator 1 comprises:

a body 2 which is secured onto the front part of the nacelle by a front attaching system 3 produced in the form of a securing bracket,

a worm drive 4 which axially extends along a working axis A, and which is rotatably mounted in the body 2,

a controlling shaft 5 forming a system for driving the worm drive 4 in rotation,

a nut 6 which is screwed on the worm drive 4,

a tubular actuating arm 7 (the upper half having been hidden for more visibility) which axially extends from a front section secured to the nut 6, to a rear section connected on the moveable rear part of the nacelle by a rear attaching system 8, in particular of type securing lug or bracket, the actuating arm 7 being slidably driven by the nut 6 along the working axis A, between a front position in which the actuating arm 7 is retracted and a rear position in which the actuating arm 7 is deployed.

Balls may be interposed between the threads of the worm drive 4 and those of the nut 6, in such a manner as to reduce friction, such that this type of actuator is currently called “ball screw”.

The controlling shaft includes a pinion, for example with oblique teeth, which cooperates with a master pinion itself directly or indirectly driven by an electric engine.

Under the action of this electric engine, the worm drive 4 pivots in one direction or the other, thereby making the nut 6 translate axially in one direction or the other, and hence elongating or retracting the actuating arm 7.

These movements of the actuating arm 7 allow transmitting a thrust and traction force, between the moveable rear part of the nacelle and the stationary front part of the nacelle.

This force passes by the front attaching system 3, the body 2, the worm drive 4, the nut 6, the actuating arm 7 and the rear attaching system 8.

Although this type of ball screw actuator operates in a satisfactory manner, it poses a breakdown risk if one of the aforementioned pieces allowing the passage of force was to break or become damaged, a risk which could be critical if the capacity of the jack of transmitting the traction forces between the two elements it connects became lost.

### SUMMARY

The present disclosure provides an actuator for aircraft turbojet engine nacelle, which is interposed between a stationary front part of the nacelle and a moveable rear part of the nacelle, the actuator including:

a body which is suitable to be secured onto the front part of the nacelle by a front main attaching system,

a worm drive which axially extends along a working axis, and which is mounted in rotation in the body,

a device for driving the worm drive in rotation,

a main nut which is screwed on the worm drive,

a main actuating arm which axially extends from a front section secured to the main nut, to a rear section suitable for being connected on the moveable rear part of the nacelle by a rear main attaching system, said arm being slidably driven by the main nut along the working axis, between a front position in which the main arm is retracted and a rear position in which the main arm is deployed, characterized in that the actuator includes a secondary actuating arm which axially extends from a rear section suitable for being connected on the moveable rear part of the nacelle, to a front section secured to the main nut, the secondary actuating arm being designed for overcoming a breakdown of the main arm.

According to this feature, the secondary arm allows a continuity of operation of the actuator in the event of breakdown or rupture of the main arm of the actuator.

The front and rear main attaching systems may be of securing lug, plating or bracket type, in particular by screwing, riveting, or any type of equivalent securing.

The device for rotationally driving may be of the type comprising an engine, for example electric and for example rotary, mechanically coupled to the worm drive in order to drive the latter in rotation.

According to another feature, the main arm forms a first half-tube and the secondary arm forms a second complementary half-tube, said half-tubes extend along the working axis and are superimposed and secured together in order to form an axial tube in which the worm drive is arranged.

This design allows in particular to not increase the size of the actuator with respect to the existing type of actuator.

Moreover, the first half-tube and the second half-tube each include a pair of complementary radial wings which axially extend and cooperate together in order to secure the first half-tube onto the second half-tube.

In addition, the main arm and the secondary arm are symmetrical along an axial symmetry plane passing by the working axis.

The symmetry favors producing the actuator according to the present disclosure.

According to another aspect, the actuator includes a secondary nut which is screwed on the worm drive and which is secured to the secondary arm in order to allow driving the secondary arm slidably along the working axis, between a front position in which the secondary arm is retracted and a rear position in which the secondary arm is deployed.

The secondary nut allows transmitting a force between the secondary arm and the screw in the event of rupture of the main nut.

Moreover, the rear main attaching system includes a main lug which is formed by a first part secured to the main arm and a second part secured to the secondary arm.

This feature allows the main lug to duplicate the path of force, the first part and the second part each being designed for transmitting a force between the associated arm and the moveable rear part of the nacelle.

According to another aspect, the actuator is equipped with a rear secondary attaching system including a secondary lug which is formed by a first part secured to the main arm and a second part secured to the secondary arm.

This feature allows the secondary lug to duplicate the path of force, the first part and the second part each being designed for transmitting a force between the associated arm and the moveable rear part of the nacelle.

According to another feature, the actuator includes a front secondary attaching system which is designed for connecting the front part of the nacelle on the actuator in order to allow a passage of force between the front part of the nacelle and the actuator, and which is designed for overcoming a breakdown of the front main attaching system.

In addition, the actuator includes a reinforcing rod which axially extends along the working axis, and which includes a front section connected on the body of the actuator and a rear section threaded in a bore of the worm drive in order to axially retain the screw in the event of rupture of the screw.

Thus, even in the event of break, the worm drives will be able to transmit a traction force.

According to another aspect, the front secondary attaching system includes a secondary front plating which is designed to be secured on the front part of the nacelle and which is connected on the body by means of the front section of the reinforcing rod.

Finally, the front section of the rod collaborates with the secondary plating in such a manner as to allow mounting the actuator by the front without dismantling said secondary plating.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial perspective view, which illustrates an actuator of ball screw type according to the prior art;

FIG. 2 is a perspective schematic view, which represents a turbojet engine nacelle equipped with an actuator according to the present disclosure;

FIG. 3 is a perspective cutaway view, which illustrates the actuator of FIG. 2 including a main arm and a secondary arm;

FIG. 4 is a perspective detailed view, which illustrates the front main attaching system and the secondary attaching system of the actuator;

FIG. 5 is a detailed exploded perspective view, which illustrates the main arm and the secondary arm of FIG. 3 according to the present disclosure;

FIG. 6 is an axial section view, which illustrates the main arm and the secondary arm of FIG. 3 in a retracted position; and

FIG. 7 is a partial perspective view, which illustrates a variant of the actuator according to the present disclosure.

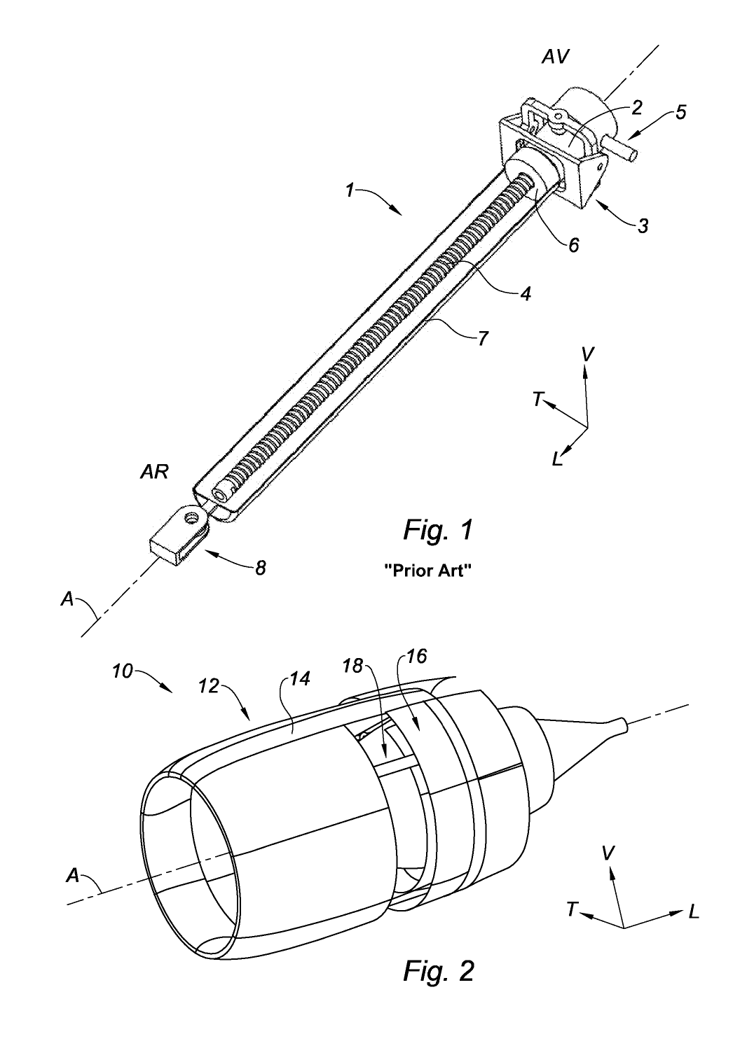

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

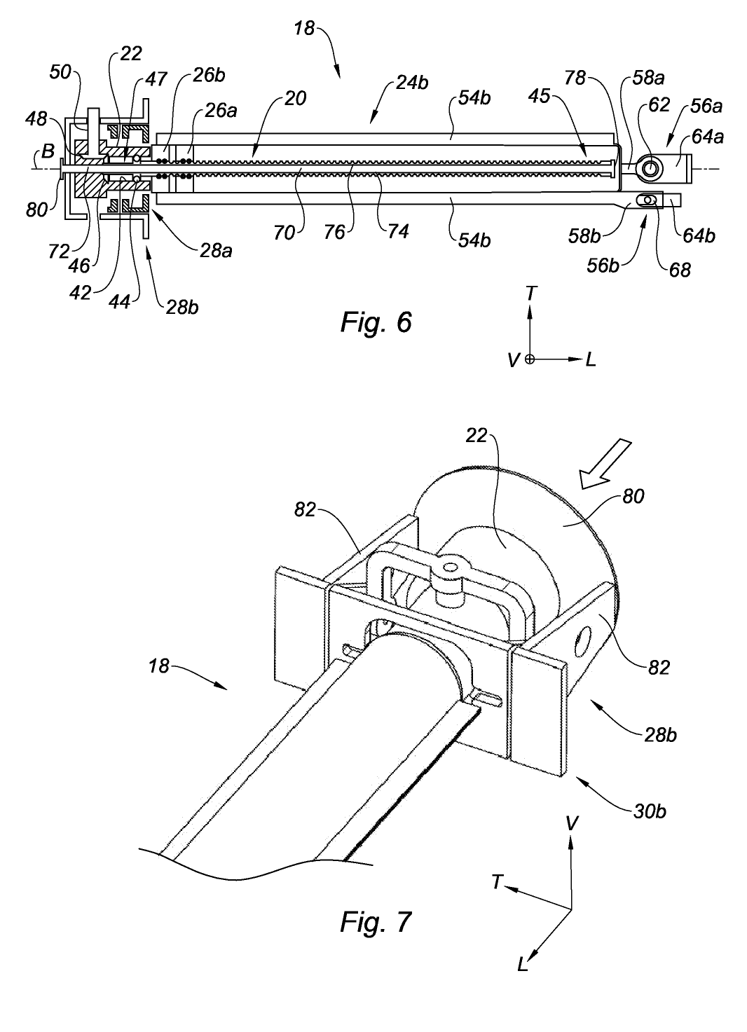

In the description and claims, it will be used in a non-limiting manner the expressions “front” and “rear”, with reference to the left side and the right side respectively of FIG. 6.

Moreover, in order to clarify the description and claims, it will be adopted in a non-limiting manner the terminology longitudinal, vertical and transversal with reference to the trihedral L, V, T indicated in the figures, of which the longitudinal axis L is substantially parallel with the axis A of the nacelle.

It has been represented on FIG. 2 an aircraft turbojet engine nacelle 10, which axially extends along a longitudinal axis A.

The nacelle 10 includes a stationary front part 12 which includes a central beam 14 for securing on the aircraft, and a moveable rear part 16 which is here a thrust reversal shutter.

The moveable rear part 16 of the nacelle 10 is driven in displacement by means of two actuators 18 arranged on either side of the beam 14, of which only one is detailed hereinafter and represented on FIG. 2.

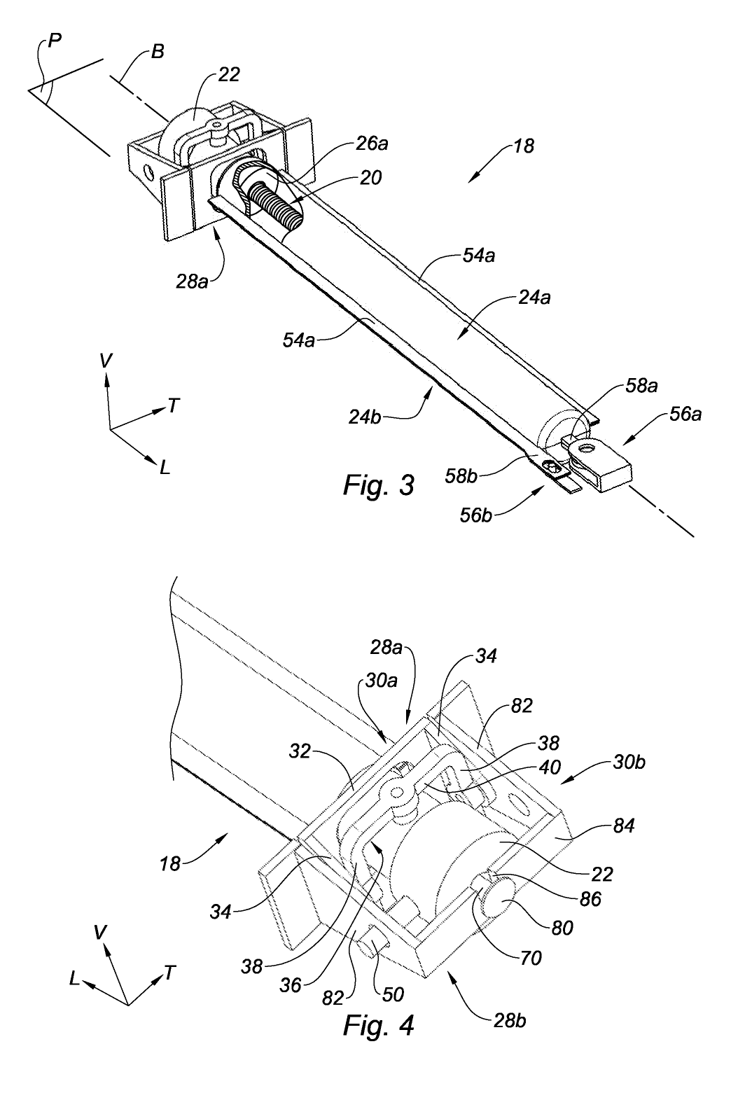

The actuator 18, represented in detail on FIGS. 3 to 7, extends from front to rear along a longitudinal working axis B.

With reference to FIGS. 3 and 6, the actuator 18 is composed by a worm drive 20 which is rotationally mounted in a body 22 and which drives in axial sliding a main arm 24a by means of a main nut 26a.

The body 22, which has a globally cylindrical form along the working axis B, is secured on the front part 12 of the nacelle 10 by a front main attaching system 28a.

As can be seen on FIG. 4, the front main attaching system 28a includes a front main U-shaped plating 30a which is composed of a transversal attaching plate 32 and two longitudinal branches which extend from the plate 32.

The attaching plate 32 is secured on the front part 12 of the nacelle 10, for example by screws (not represented), and the two associated branches 34 carry a universal joint 36.

The universal joint 36 has an annular form formed by two vertical branches 38 which are pivotally mounted on the front main plating 30a around a transversal axis, and two transversal branches 40 (of which only one is represented) which carry the body 22 of the actuator 18, in such a manner as to allow a ball joint movement of the body 22.

Moreover, in reference to FIG. 6, the body 22 delimits a central bore 42 along the axis B, which is equipped with a ball bearing 44.

In a complementary manner, the worm drive 20 extends longitudinally along the working axis B from a rear section 45, to a front driving section 47 which is rotationally mounted in the ball bearing 44 around the axis B.

In addition, the front section 47 of the worm drive 20 includes at the front axial end thereof a driven pinion 46 with oblique teeth which cooperates with an engine pinion 48 also with oblique teeth.

The engine pinion 48 is rotationally connected on an engine shaft 50 which extends perpendicularly to the worm drive 20.

The engine shaft 50 is rotationally driven, for example by an electric engine (not represented), in one direction or in another opposite direction in order to rotationally drive the worm drive 20 in one direction or in another opposite direction. Thus, it is provided a driving device comprising this rotary engine which rotationally drives the engine shaft 50 which is mechanically coupled to the worm drive 20 via the pinions 46, 48 for rotationally driving the worm drive 20. It is to be considered to provide another type of driving device, for example with an engine shaft parallel with the worm drive 20, and in particular in the alignment of the worm drive 20.

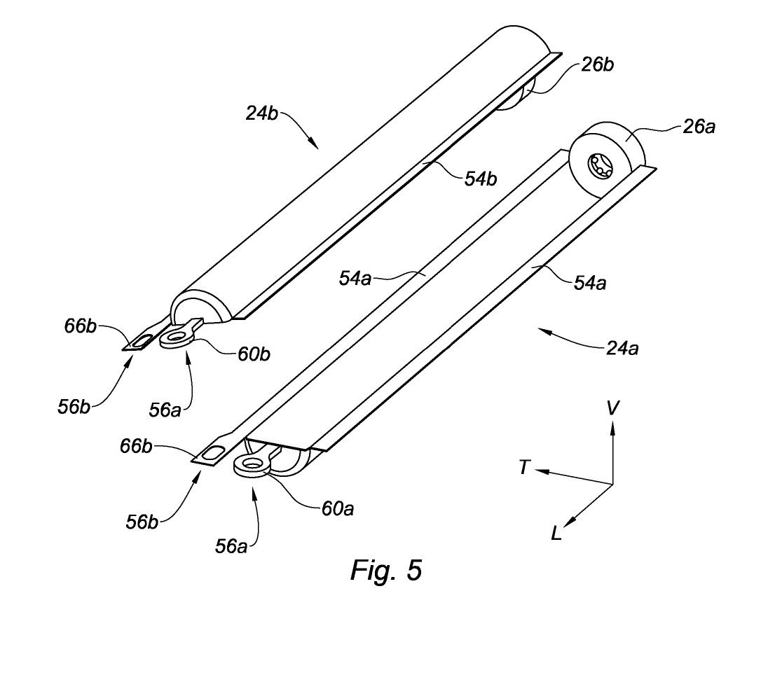

As it can be seen on FIGS. 3 and 5, the main actuating arm 24a is duplicated by a secondary actuating arm 24b which is symmetrically arranged along a transversal plane P passing by the working axis B.

The main actuating arm 24a and the secondary actuating arm 24b each axially extend from a rear section suitable for being connected on the moveable rear part 16 of the nacelle 10, to a front section secured to the main nut 26a.

The main nut 26a is screwed on the worm drive 20 in such a manner as to slidably drive the main actuating arm 24a and the secondary actuating arm 24b along the working axis B, between a front position in which the arms 24a, 24b are retracted, and a rear position in which the arms 24a, 24b are deployed.

Advantageously, the actuator 18 includes a secondary nut 26b which is screwed on the worm drive 20, proximate to the main nut 26a, and which is secured to the secondary actuating arm 24b.

Thus, the secondary nut 26b allows driving in displacement the secondary actuating arm 24b in order to overcome a breakdown of the main nut 26a, such as for example a rupture.

Balls are interposed between the threads of the worm drive 20 and those of the main nut 26a and the secondary nut 26b, in such a manner as to reduce friction.

In reference to FIG. 5, the main actuating arm 24a and the secondary actuating arm 24b respectively form a first half-tube and a second complementary half-tube, which extend along the working axis B.

Each half-tube includes a pair of radial wings 54a, 54b respectively which axially extend and which cooperate together in order to secure the main actuating arm 24a and the secondary actuating arm 24b together, for example by means of a set of screws (not represented), for forming an axial tube in which the worm drive 20 is arranged.

In a non-limiting manner, the main actuating arm 24a and the secondary actuating arm 24b may respectively form a first tube and a second tube (not represented) which are arranged inside each other in a coaxial manner along the working axis B.

According to another aspect, the main actuating arm 24a and the secondary actuating arm 24b are connected on the moveable rear part 16 of the nacelle 10 by a rear main attaching system 56a and by a rear secondary attaching system 56b.

The rear main attaching system 56a includes a main lug 58a which is formed by a first part 60a secured to the main actuating arm 24a and a second part 60b secured to the secondary actuating arm 24b.

The main lug 58a delimits a hole 62 suitable for securing a rear main plating 64a which is intended to be coupled on the moveable rear part 16 of the nacelle 10 by means of a ball-joint and an axis which are not represented.

Similarly, the secondary attaching system 56b includes a secondary lug 58b which is formed by a first part 66a secured to the main actuating arm 24a and a second part 66b secured to the secondary actuating arm 24b.

Moreover, the secondary lug 58b delimits an oblong hole 68 designed for securing a rear secondary plating 64b intended to be coupled on the moveable rear part 16 of the nacelle 10.

Thus, the rear secondary attaching system 56b allows transmitting a force between the actuator 18 and the moveable rear part 16 of the nacelle 10 only in the event of breakdown of the rear main attaching system 56b, and not in normal operating conditions.

To this end, the rear secondary plating 64b of the rear secondary attaching system 56b is coupled on the moveable rear part 16 of the nacelle 10 with axial clearance.

According to another feature of the present disclosure illustrated on FIG. 6, the actuator 18 includes a reinforcing rod 70 which axially extends along the working axis B, and which includes a front section 72 crossing the body 22 of the actuator 18 and a rear section 74 threaded in a bore 76 of the worm drive 20 in order to axially retain the screw in the event of break of the worm drive 20.

To this end, the rear free end of the rod 70 delimits a first shoulder 78 which blocks the worm drive 20 in axial translation towards the rear, and the front free end of the rod 70 delimits a second shoulder 80 which blocks the worm drive 20 in axial translation towards the rear, with an axial clearance allowing to not pass any force by this normal operating path.

Finally, as it can be seen in detail on FIG. 4, the actuator 18 includes a front secondary attaching system 28b which is designed for connecting the front part 12 of the nacelle 10 on the actuator 18, and for overcoming a breakdown of the front main attaching system 28a.

To this end, the front secondary attaching system 28b includes a front secondary U-shaped plating 30b which is composed of two longitudinal branches 82 and a front transversal plate 84.

The two branches 82 are secured on the front part 12 of the nacelle 10, for example by screws (not represented), and the front plate 84 is axially interposed between the body 22 and the second shoulder 80 of the rod 70 in order to allow the passage of force between the front part 12 of the nacelle 10 and the actuator 18.

The front plate 84 of the front secondary attaching system 28b delimits a vertically open notch 86, in order to allow the dismantling and mounting of the actuator 18 without dismantling the front secondary plating 30b.

According to a variant represented on FIG. 7, the second shoulder 80 of the rod 70 forms a radial disk which axially bears towards the rear against the two branches 82 of the front secondary attaching system 28b.

This feature allows dismantling and mounting the actuator 18 without dismantling the front secondary plating 30b, by introducing the jack by the front, such as shown by the arrow in FIG. 7.

The actuator 18 according to the present disclosure allows “duplicating” the main path of force which is taken during the “normal” operating of the actuator 18, in order to provide the transmission of a traction force between the stationary front part 12 and the moveable rear part 16 of the nacelle 10.

In fact, a traction force may successively be transmitted by a secondary path of force along the front secondary attaching system 28b, the reinforcing rod 70, the secondary nut 26b, the secondary arm 24b and the rear secondary attaching system 56b.

In a general manner, the secondary path of force is taken only for the passage of a force in the event of rupture or breakdown of a piece from the main path of force.

What is claimed is:

1. An actuator for an aircraft turbojet engine nacelle, which is interposed between a stationary front part of the nacelle, and a moveable rear part of the nacelle, the actuator comprising:
a body secured onto the front part of the nacelle by a front main attaching system;
a worm drive configured to axially extend along a working axis, and rotatably mounted in the body;
a device for driving the worm drive in rotation;
a main nut screwed on the worm drive; and
a main actuating arm configured to axially extend from a front section secured to the main nut, to a rear section connected on the moveable rear part of the nacelle by a rear main attaching system, said main actuating arm being slidably driven by the main nut along the working axis, between a front position in which the main actuating arm is retracted and a rear position in which the main actuating arm is deployed,
wherein the actuator comprises a secondary actuating arm configured to axially extend from a rear section connected on the moveable rear part of the nacelle, to a front section secured to the main nut, the secondary actuating arm configured to overcome a breakdown of the main actuating arm.

2. The actuator for nacelle according to claim 1, wherein the main actuating arm forms a first half-tube and the secondary arm forms a second complementary half-tube, said half-tubes extend along the working axis and are superimposed and secured together in order to form an axial tube in which the worm drive is arranged.

3. The actuator for nacelle according to claim 2, wherein the first half-tube and the second half-tube each include a pair of complementary radial wings which axially extend and cooperate together in order to secure the first half-tube onto the second half-tube.

4. The actuator for nacelle according to claim 1, wherein the main actuating arm and the secondary actuating arm are symmetrical along an axial symmetry plane passing by the working axis.

5. The actuator for nacelle according to claim 1, further comprising a secondary nut screwed on the worm drive and secured to the secondary actuating arm in order to allow driving the secondary actuating arm slidably along the working axis, between a front position in which the secondary actuating arm is retracted and a rear position in which the secondary actuating arm is deployed.

6. The actuator for nacelle according to claim 1, wherein the rear main attaching system comprises a main lug which is formed by a first part secured to the main actuating arm and a second part secured to the secondary actuating arm.

7. The actuator for nacelle according to claim 1, wherein the actuator is equipped with a rear secondary attaching system including a secondary lug which is formed by a first part secured to the main actuating arm and a second part secured to the secondary actuating arm.

8. The actuator for nacelle according to claim 1, further comprising a front secondary attaching system configured to connect the front part of the nacelle on the actuator to allow a passage of force between the front part of the nacelle and the actuator, and the front secondary attaching system configured to overcome a breakdown of the front main attaching system.

9. The actuator for nacelle according to claim 1, wherein the actuator comprises a reinforcing rod which axially extends along the working axis, and which includes a front section connected on the body of the actuator and a rear section threaded in a bore of the worm drive to axially retain a screw in the event of rupture of the screw.

10. The actuator for nacelle according to claim 8, wherein the front secondary attaching system includes a front secondary plating which is secured on the front part of the nacelle and which is connected on the body by means of a front section of a reinforcing rod.

11. The actuator for nacelle according to claim 10, wherein the front section of the reinforcing rod collaborates with the front secondary plating so as to allow mounting the actuator by the front section without dismantling the front secondary plating.
